(19) United States
(12) Patent Application Publication
(10) Pub. No.: US 2004/0239252 A1
(43) Pub. Date: Dec. 2, 2004

(54) Plasma display panel

(75) Inventors: Kazuya Akiyama, Yamanashi-ken (JP); Naruhiko Atsuchi, Yamanashi-ken (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/855,405

(22) Filed: May 28, 2004

(30) Foreign Application Priority Data
May 30, 2003 (JP) 2003-155532
May 30, 2003 (JP) 2003-155533

(51) Int. Cl. H01J 17/49

(52) U.S. Cl. 313/587; 313/582; 313/584

(57) ABSTRACT

A front glass substrate and a back glass substrate face each other with a discharge space in between. A phosphor layer is provided on the back glass substrate for colored-light emission by means of a discharge produced in the discharge space. The phosphor layer is formed of a phosphor thin film having visible-light transmission properties. A column-electrode protective layer and a partition wall have black- or dark-colored faces in contact with a face of the phosphor layer opposite a face facing toward the front substrate.

### BACKGROUND OF THE INVENTION

1. Field of the Invention

This invention relates to a structure of a plasma display panel.

The present application claims priority from Japanese Applications No. 2003-155532 and No. 2003-155533, the disclosure of which is incorporated herein by reference.

2. Description of the Related Art

FIG. 1 is a sectional view of the structure of a discharge cell of a conventional surface-discharge-type and reflection-type plasma display panel (hereinafter referred to as “PDP”).

In FIG. 1, each of the row electrode pairs (X, Y) is provided on the rear-facing face of the front glass substrate 1 serving as the display surface so as to face the discharge cells C and extends in the row direction (i.e. in a direction at right angle to the plane of the drawing).

Each of the row electrodes X, Y is composed of a strip-shaped bus electrode Xa (or Ya) formed of a metal film extending in the row direction, and transparent electrodes Xb (or Yb) each formed of a transparent conductive film made of ITO or the like. The transparent electrodes Xb and Yb are regularly spaced along the corresponding bus electrodes Xa and Ya at regular intervals. The transparent electrode Xb and the transparent electrode Yb face each other with a discharge gap g in between.

The row electrode pairs (X, Y) are covered with a dielectric layer 2 provided on the rear-facing face of the front glass substrate 1. On the dielectric layer 2 in turn an MgO-made protective layer 3 is provided.

The front glass substrate 1 is opposite and parallel to a back glass substrate 4 with a discharge space in between. On the front-facing face of the back glass substrate 4 facing toward the front glass substrate 1 are column electrodes D provided to create discharge cells C in the discharge space in correspondence with the intersection with the row electrode pairs (X, Y). The column electrodes D are arranged at regular intervals and each extend in the column direction (i.e. the right-left direction in FIG. 1) through positions each opposite the paired transparent electrodes Xb and Yb of each row electrode pair (X, Y).

The column electrodes D are covered with a white-colored column-electrode protective layer (dielectric layer) 5 provided on the front-facing face of the back glass substrate 4.

A white-colored partition wall 6 is provided on the column-electrode protective layer 5 to individually define the discharge cells C. In each of the discharge cells C defined by the partition wall 6, a phosphor layer 7 overlies the surface of the column-electrode protective layer 5 and the side faces of the partition wall 6.

The phosphor layer 7 is formed of a phosphor powder of a red, green or blue color applied as a coating to each discharge cell C for color display by the use of screen printing techniques or the like.

Further the PDP has a circularly-polarized-light filter layer 8 provided on the display surface of the front glass substrate 1 in order to prevent image contrast from being decreased by ambient light incident on the panel surface.

Such a structure of the conventional PDP is described in Japanese Patent Laid-open application No. 11-242933.

The conventional PDP, however, has the phosphor layer 7 formed of the phosphor powder, so that when ambient light penetrating the panel surface is reflected off the surface of the phosphor layer 7, the polarization is perturbed. Hence the PDP has the problem of a reduction in the capability of the circularly-polarized-light filter layer 8 to prevent the reflection of ambient light.

In the typical PDPs, vacuum ultraviolet light (VUV) is radiated from the xenon included in the discharge gas sealed in the discharge space by means of a sustaining emission discharge d generated between the row electrodes X and Y, then the vacuum ultraviolet light excites the phosphor layer, whereupon the phosphor layer emits visible light. With regard to this emission, when the phosphor layer is formed of the phosphor powder as in the conventional PDP, the coating is low in the density. This poses limits to increasing the brightness of the panel.

The PDPs include a so-called transmission-type PDP having a phosphor layer provided on the front glass substrate, besides the so-called reflection-type PDP having the phosphor layer 7 provided on the back glass substrate 4 as described above. When a phosphor layer formed of phosphor powder is used in the transmission-type PDP, the visible light radiated from the phosphor layer when excited by the vacuum ultraviolet light is scattered and absorbed by the phosphor powder forming the phosphor layer. For this reason, the problem of a decrease in the emissivity of the visible light from the panel surface toward the outside to effect a reduction in the brightness arises.

### SUMMARY OF THE INVENTION

The present invention is made essentially to solve the problems associated with the conventional plasma display panel as described hitherto.

Accordingly it is a first object of the present invention to minimize the reflection of the ambient light penetrating the panel surface of a plasma display panel for prevention of the lowering of the image contrast.

It is a second object of the present invention to provide a transmission-type plasma display panel with a simple structure which is capable of increasing the brightness.

To attain the first object, a plasma display panel according to a first aspect of the present invention comprises: a front substrate and a back substrate facing each other with a discharge space in between; a phosphor layer provided on the back substrate for colored-light emission by means of a discharge produced in the discharge space, and formed of a phosphor thin film having visible-light transmission properties; and either a black-colored or a dark-colored layer provided on a face of the phosphor layer opposite a face facing toward the front substrate.

In the plasma display panel according to the first aspect, a phosphor layer located on the black substrate is formed of a transmissive phosphor thin film. Therefore, the ambient light penetrating the panel surface is not diffusely reflected off the surface of the phosphor layer as happens in the conventional PDP. The ambient light passing through the phosphor layer because of the visible-light transmission properties of the phosphor layer is absorbed by the black- or dark-colored layer of the plasma display panel located on the rear-facing face of the phosphor layer.

For these reasons, with the plasma display panel, the ambient light penetrating the panel surface is absorbed by the black- or dark-colored layer located on the rear-facing face of the phosphor layer to be prevented from reflecting, resulting in the prevention of the image contrast being lowered by the reflection of the ambient light.

To attain the first object, a plasma display panel according to a second aspect of the present invention comprises: a front substrate and a back substrate facing each other with a discharge space in between; and a phosphor layer that is provided on the back substrate for colored-light emission by means of a discharge produced in the discharge space, and is formed of a phosphor thin film having visible-light transmission properties and a refractive index smaller than a refractive index of a portion of the back substrate in contact with the phosphor layer, and having a film thickness corresponding to approximately a quarter wavelength of light.

In the plasma display panel according to the second aspect, the phosphor layer is formed of a transmissive phosphor thin film. Therefore, the ambient light penetrating the panel surface is not diffusely reflected off the surface of the phosphor layer as happens in the conventional PDP. Further, the phosphor layer has a film thickness corresponding to approximately a quarter wavelength of light and a refractive index smaller than the refractive index of the portion of the back substrate in contact with on the phosphor layer. For this reason, the interference of the ambient light passing through the panel surface and reflected off the surface of the phosphor layer with the ambient light reflected off the components of the plasma display panel in contact with the phosphor layer on the back substrate occurs to reduce the ambient light. The PDP thus prevents the lowering of the image contrast caused by the reflection of the ambient light.

To attain the first object, a plasma display panel according to a third aspect of the present invention comprises: a front substrate and a back substrate facing each other with a discharge space in between; a phosphor layer provided on the back substrate for colored-light emission by means of a discharge produced in the discharge space, and formed of a phosphor thin film with visible-light transmission properties; and a circularly-polarized-light filter layer provided on the front substrate.

In the plasma display panel according to the third aspect, the phosphor layer is formed of a transmissive phosphor thin film, and further a circularly-polarized-light filter layer is provided on the front substrate.

Accordingly, the circularly-polarized-light filter layer prevents the ambient light penetrating the panel surface from travelling out again through the panel surface. In consequence, the lowering of the image contrast caused by the reflection of the ambient light is prevented.

Further, because the phosphor layer is formed of a phosphor thin film, as compared with the conventional case of the phosphor layer formed of a phosphor powder, it is possible to reduce the perturbation of the polarization on the reflection face of the phosphor layer, thereby enhancing the effect of the circularly-polarized-light filter layer to prevent the reflection of the ambient light.

To attain the second object, a plasma display panel according to a fourth aspect of the present invention comprises: a front substrate and a back substrate facing each other with a discharge space in between; a phosphor layer provided on the front substrate for radiating visible light by means of ultraviolet light generated in the discharge space, and formed of a phosphor film having visible-light transmission properties; and a reflection layer provided on the back substrate for reflecting at least the ultraviolet light.

In the plasma display panel according to the fourth aspect, the discharge produced in the discharge space between the front substrate and the back substrate causes the generation of ultraviolet light from a discharge gas sealed in the discharge space. The ultraviolet light excites the phosphor layer formed on the front substrate to allow the phosphor layer to emit visible light for the generation of the image according to the image signal.

In this event, the phosphor layer is formed of the phosphor film, so that the density is increased as compared with the conventional phosphor layer formed of a coating of phosphor powder. As a result, an improvement in the brightness of the panel is achieved.

Further, because of the phosphor layer formed of the transmissive phosphor film, the visible light radiated from the phosphor layer excited by the ultraviolet light is not scattered and absorbed by the phosphor layer. This makes the formation of a transmission-type PDP possible.

Still further, because the reflection layer is provided on the back substrate opposite the phosphor layer, the reflection layer reflects, toward the front substrate, the portions of the ultraviolet light generated from the discharge gas and the visible light radiated from the phosphor layer which travel toward the back substrate. This reflection allows the achievement of an improvement in brightness of the plasma display panel.

Because of the location of the reflection layer on the back substrate, the reflection layer has no need of having a high light transmittance of the visible light as in the case where an ultraviolet-light reflection layer is provided on the front substrate. This makes it possible to improve the luminous efficiency with the use of a simple film structure such as a metal film covered with an insulation layer, for example.

These and other objects and features of the present invention will become more apparent from the following detailed description with reference to the accompanying drawings.

### BRIEF DESCRIPTION OF THE DRAWINGS

FIG. 1 is a front view of the partial structure of a conventional PDP.

FIG. 2 is a sectional view illustrating a first embodiment of the present invention.

FIG. 3 is a sectional view illustrating a second embodiment of the present invention.

FIG. 4 is a sectional view illustrating a third embodiment of the present invention.

FIG. 5 is a sectional view illustrating a fourth embodiment of the present invention.

FIG. 6 is a diagram illustrating the structure of a circularly-polarized-light filter layer in the fourth embodiment.

FIG. 7 is a diagram illustrating the principle of preventing the reflection of ambient light by means of the circularly-polarized-light filter layer.

FIG. 8 is a front view illustrating a fifth embodiment of the present invention.

FIG. 9 is a sectional view taken along the V-V line in FIG. 8.

FIG. 10 is a sectional view illustrating a sixth embodiment of the present invention.

### DETAILED DESCRIPTION OF THE PREFERRED EMBODIMENTS

Preferred embodiments according to the present invention will be described below in detail with reference to the accompanying drawings.

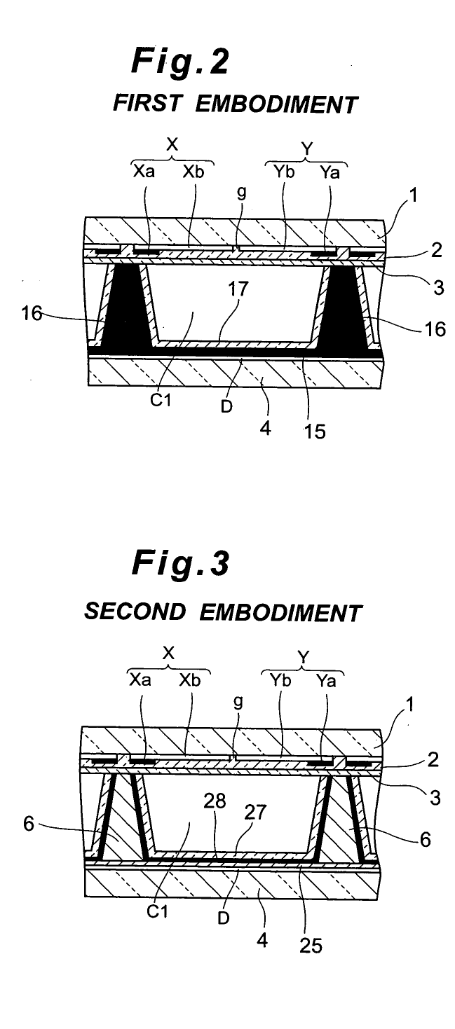

FIG. 2 is a sectional view illustrating a first embodiment of a PDP according to the present invention.

In FIG. 2, each of row electrode pairs (X, Y) extends along the row direction (i.e. the vertical direction at right angles to the plane of the drawing) in portion of the rear-facing face of a front glass substrate 1 (serving as the display surface) facing discharge cells C1.

Each of the row electrodes X, Y is composed of a strip-shaped bus electrode Xa (or Ya) formed of a metal film extending in the row direction, and transparent electrodes Xb (or Yb) each formed of a transparent conductive film made of ITO or the like. The transparent electrodes Xb and Yb are regularly spaced along the corresponding bus electrodes Xa and Ya at regular intervals. The transparent electrode Xb and the transparent electrode Yb face each other with a discharge gap g in between.

The row electrode pairs (X, Y) are covered with a dielectric layer 2 provided on the rear-facing face of the front glass substrate 1. On the dielectric layer 2 in turn an MgO-made protective layer 3 is provided.

The front glass substrate 1 is opposite and parallel to a back glass substrate 4 with a discharge space in between. On the front-facing face of the back glass substrate 4 facing toward the front glass substrate 1 are column electrodes D provided thereon to create the discharge cells C1 in the discharge space in correspondence with the intersection with the row electrode pairs (X, Y). The column electrodes D are arranged at regular intervals and each extend in the column direction (i.e. the right-left direction in FIG. 2) through positions each opposite to the paired transparent Xb and Yb of each row electrode pair (X, Y).

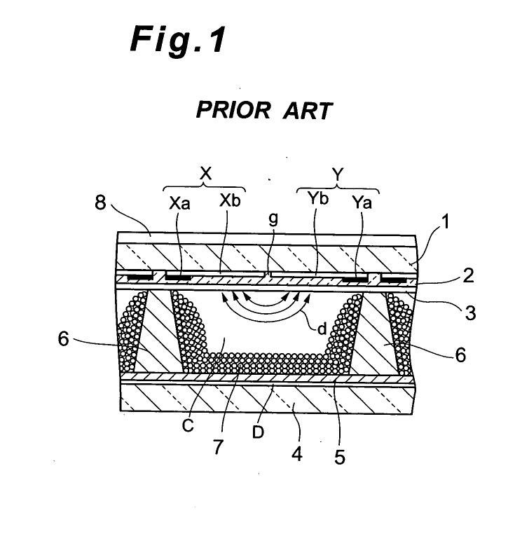

The above structure is the same as that in the conventional PDP described in FIG. 1 and the same reference numerals are designated.

The column electrodes D are covered with a black- or dark-colored column-electrode protective layer (dielectric layer) 15 including a black- or dark-colored pigment provided on the front-facing face of the back glass substrate 4.

A black- or dark-colored partition wall 16 including a black- or dark-colored pigment is provided on the column-electrode protective layer 15 to individually define the discharge cells C1.

The black-colored pigments included in the column-electrode protective layer 15 and the partition wall 16 includes, for example, iron oxide, cobalt oxide, chromium oxide and the like.

In each of the discharge cells C1 defined by the partition wall 16, a phosphor layer 17 overlies the surface of the column-electrode protective layer 15 and the side faces of the partition wall 16. The phosphor layer 17 is formed of a phosphor thin film having visible-light transmission properties.

Red (R), green (G) and blue (B) colors are individually applied to the phosphor layers 17 in the discharge cells C1 for color display so that the red (R), green (G) and blue (B) colors are arranged in order in the row direction or the column direction.

The phosphor thin film forming the red phosphor layer 17 has composition, for example, (Y, Gd, Eu) BO₃, (Y, Eu)₂O₃, (Y, Gd, Eu)₂O₃, or the like. The phosphor thin film forming the green phosphor layer 17 has composition, for example, (Zn, Mn)₂SiO₄, (Y, Tb)BO₃, (Y, Tb)₂O₃, or the like. The phosphor thin film forming the blue phosphor layer 17 has composition, for example, (Ba, Eu)MgAL₁₀O₁₇, (Ca, Eu)MgSi₂O₆, (Y, Tm)₂O₃, or the like.

The transmissive phosphor thin film forming the phosphor layer 17 is formed by the use of CVD (Chemical Vapor Deposition) techniques, sputtering techniques, EB (Electron Beam) deposition techniques or the like.

The PDP in the first embodiment has the phosphor layer 17 formed of a transmissive phosphor thin film. Therefore, the ambient light entering the panel surface is not diffusely reflected off the surface of the phosphor layer as happens in the conventional PDP. The ambient light passing through the phosphor layer because of the visible-light transmission properties of the phosphor layer is absorbed by the black- or dark-colored column-electrode protective layer 15 and partition wall 16, resulting in the prevention of the image contrast being lowered by the reflection of the ambient light.

FIG. 3 is a sectional view illustrating a second embodiment of a PDP according to the present invention.

In FIG. 3, each of row electrode pairs (X, Y) extends along the row direction (i.e. the vertical direction at right angles to the plane of the drawing) in portion of the rear-facing face of a front glass substrate 1 (serving as the display surface) facing discharge cells C1.

Each of the row electrodes X, Y is composed of a strip-shaped bus electrode Xa (or Ya) formed of a metal film extending in the row direction, and transparent electrodes Xb (or Yb) each formed of a transparent conductive film made of ITO or the like. The transparent electrodes Xb and Yb are regularly spaced along the corresponding bus electrodes Xa and Ya at regular intervals. The transparent electrode Xb and the transparent electrode Yb face each other with a discharge gap g in between.

The row electrode pairs (X, Y) are covered with a dielectric layer 2 provided on the rear-facing face of the front glass substrate 1. On the dielectric layer 2 in turn an MgO-made protective layer 3 is provided.

The front glass substrate 1 is opposite and parallel to a back glass substrate 4 with a discharge space in between. The front-facing face of the back glass substrate 4 facing toward the front glass substrate 1 has column electrodes D provided thereon to create discharge cells C1 in the discharge space in correspondence with the intersection with the row electrode pairs (X, Y). The column electrodes D are arranged at regular intervals and each extend in the column direction (i.e. the right-left direction of the drawing sheet of FIG. 3) through positions each opposite to the paired transparent Xb and Yb of each row electrode pair (X, Y).

A white-colored column-electrode protective layer (dielectric layer) 25 is provided on the front-facing face of the back glass substrate 4 and covers the column electrodes D. On the column-electrode protective layer 5, a white-colored partition wall 6 is provided to define the individual discharge cells C1.

The above structure is the same as that in the conventional PDP described in FIG. 1 and the same reference numerals are designated.

In each of the discharge cells C1 defined by the partition wall 6, a black- or dark-colored light absorption layer 28 overlies the surface of the column-electrode protective layer 25 and the side faces of the partition wall 6. On the light absorption layer 28, a phosphor layer 27 formed of a phosphor thin film having visible-light transmission properties is provided.

Red (R), green (G) and blue (B) colors are individually applied to the phosphor layers 27 in the discharge cells C1 for color display so that the red (R), green (G) and blue (B) colors are arranged in order in the row direction or the column direction.

The phosphor thin film forming the red phosphor layer 27 has composition, for example, (Y, Gd, Eu) BO₃, (Y, Eu)₂O₃, (Y, Gd, Eu)₂O₃, or the like. The phosphor thin film forming the green phosphor layer 27 has composition, for example, (Zn, Mn)₂SiO₄, (Y, Tb)BO₃, (Y, Tb)₂O₃, or the like. The phosphor thin film forming the blue phosphor layer 27 has composition, for example, (Ba, Eu)MgAL₁₀O₁₇, (Ca, Eu)MgSi₂O₆, (Y, Tm)₂O₃, or the like.

The transmissive phosphor thin film forming the phosphor layer 27 is produced by the use of a CVD (Chemical Vapor Deposition) method, sputtering techniques, an EB (Electron Beam) deposition method or the like.

The PDP in the second embodiment has the phosphor layer 27 formed of a transmissive phosphor thin film. Therefore, the ambient light entering the panel surface is not diffusely reflected off the surface of the phosphor layer as happens in the conventional PDP. The ambient light passing through the phosphor layer 27 because of its visible-light transmission properties is absorbed by the black- or dark-colored light absorption layer 28, resulting in the prevention of the image contrast being lowered by the reflection of the ambient light.

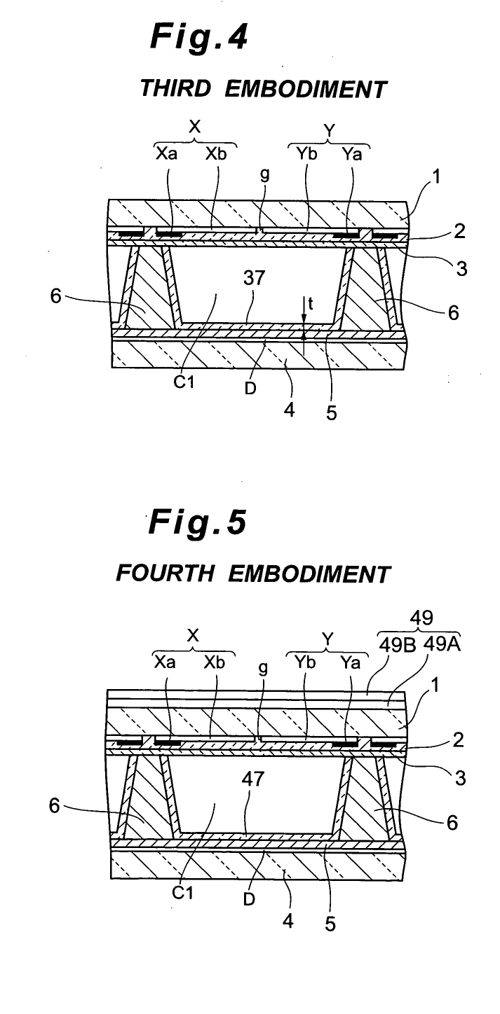

FIG. 4 is a sectional view illustrating a third embodiment of a PDP according to the present invention.

In FIG. 4, each of row electrode pairs (X, Y) extends along the row direction (i.e. the vertical direction at right angles to the plane of the drawing) in a position of the rear-facing face of a front glass substrate 1 (serving as the display surface) facing discharge cells C1.

Each of the row electrodes X, Y is composed of a strip-shaped bus electrode Xa (or Ya) formed of a metal film extending in the row direction, and transparent electrodes Xb (or Yb) each formed of a transparent conductive film made of ITO or the like. The transparent electrodes Xb and Yb are regularly spaced along the corresponding bus electrodes Xa and Ya at regular intervals. The transparent electrode Xb and the transparent electrode Yb face each other with a discharge gap g in between.

The row electrode pairs (X, Y) are covered with a dielectric layer 2 provided on the rear-facing face of the front glass substrate 1. On the dielectric layer 2 in turn an MgO-made protective layer 3 is provided.

The front glass substrate 1 is opposite and parallel to a back glass substrate 4 with a discharge space in between. On the front-facing face of the back glass substrate 4 facing toward the front glass substrate 1 are column electrodes D provided thereon to create the discharge cells C1 in the discharge space in correspondence with the intersection with the row electrode pairs (X, Y). The column electrodes D are arranged at regular intervals and each extend in the column direction (i.e. the right-left direction in FIG. 4) through positions each opposite to the paired transparent Xb and Yb of each row electrode pair (X, Y).

A white-colored column-electrode protective layer (dielectric layer) 5 is provided on the front-facing face of the back glass substrate 4 and covers the column electrodes D. On the column-electrode protective layer 5, a white-colored partition wall 6 is provided to define the individual discharge cells C1.

The above structure is the same as that in the conventional PDP described in FIG. 1 and the same reference numerals are designated.

In each of the discharge cells C1 defined by the partition wall 6, a phosphor layer 37 overlies the surface of the column-electrode protective layer 5 and the side faces of the partition wall 6. The phosphor layer 37 is formed of a phosphor thin film having visible-light transmission properties, and has a film thickness t corresponding to approximately a quarter wavelength of light (±50%).

Red (R), green (G) and blue (B) colors are individually applied to the phosphor layers 37 in the discharge cells C1 for color display so that the red (R), green (G) and blue (B) colors are arranged in order in the row direction or the column direction.

The phosphor thin film forming the red phosphor layer 37 has composition, for example, (Y, Gd, Eu) BO₃, (Y, Eu)₂O₃, (Y, Gd, Eu)₂O₃, or the like. The phosphor thin film forming the green phosphor layer 37 has composition, for example, (Zn, Mn)₂SiO₄, (Y, Tb)BO₃, (Y, Tb)₂O₃, or the like. The phosphor thin film forming the blue phosphor layer 37 has composition, for example, (Ba, Eu)MgAL₁₀O₁₇, (Ca, Eu)MgSi₂O₆, (Y, Tm)₂O₃, or the like. Each of the red, green and blue phosphor layers 37 has a refractive index smaller than the refractive index of the materials forming the column-electrode protective layer 5 and the partition wall 6.

The transmissive phosphor thin film forming the phosphor layer 37 is created by the use of CVD (Chemical Vapor Deposition) techniques, sputtering techniques, EB (Electron Beam) deposition techniques or the like.

The PDP in the third embodiment has the phosphor layer 37 formed of a transmissive phosphor thin film. Therefore, the ambient light entering the panel surface is not diffusely reflected off the surface of the phosphor layer as happens in the conventional PDP. Further, the phosphor layer 37 has the film thickness t corresponding to approximately a quarter wavelength of light and a refractive index smaller than that of the materials forming the column-electrode protective layer 5 and the partition wall 6. This design causes the interference of the ambient light entering the panel surface and reflected off the surface of the phosphor layer 37 with the ambient light reflected off the surface of the column-electrode protective layer 5 or the partition wall 6 for a reduction in ambient light. As a result, the lowering of the image contrast caused by the reflection of the ambient light is prevented.

FIG. 5 is a sectional view illustrating a fourth embodiment of a PDP according to the present invention.

In FIG. 5, each of row electrode pairs (X, Y) extends along the row direction (i.e. the vertical direction at right angles to the plane of the drawing) in portion of the rear-facing face of a front glass substrate 1 (serving as the display surface) facing discharge cells C1.

Each of the row electrodes X, Y is composed of a strip-shaped bus electrode Xa (or Ya) formed of a metal film extending in the row direction, and transparent electrodes Xb (or Yb) each formed of a transparent conductive film made of ITO or the like. The transparent electrodes Xb and Yb are regularly spaced along the corresponding bus electrodes Xa and Ya at regular intervals. The transparent electrode Xb and the transparent electrode Yb face each other with a discharge gap g in between.

The row electrode pairs (X, Y) are covered with a dielectric layer 2 provided on the rear-facing face of the front glass substrate 1. On the dielectric layer 2 in turn an MgO-made protective layer 3 is provided.

The front glass substrate 1 is opposite and parallel to a back glass substrate 4 with a discharge space in between. On the front-facing face of the back glass substrate 4 facing toward the front glass substrate 1 are column electrodes D provided thereon to create the discharge cells C1 in the discharge space in correspondence with the intersection with the row electrode pairs (X, Y). The column electrodes D are arranged at regular intervals and each extend in the column direction (i.e. the right-left direction in FIG. 5) through positions each opposite to the paired transparent Xb and Yb of each row electrode pair (X, Y).

A white-colored column-electrode protective layer (dielectric layer) 5 is provided on the front-facing face of the back glass substrate 4 and covers the column electrodes D. On the column-electrode protective layer 5, a white-colored partition wall 6 is provided to define the individual discharge cells C1.

The above structure is the same as that in the conventional PDP described in FIG. 1 and the same reference numerals are designated.

In each of the discharge cells C1 defined by the partition wall 6, a phosphor layer 47 overlies the surface of the column-electrode protective layer 5 and the side faces of the partition wall 6. The phosphor layer 47 is formed of a phosphor thin film having visible-light transmission properties.

Red (R), green (G) and blue (B) colors are individually applied to the phosphor layers 47 in the discharge cells C1 for color display so that the red (R), green (G) and blue (B) colors are arranged in order in the row direction or the column direction.

The phosphor thin film forming the red phosphor layer 47 has composition, for example, (Y, Gd, Eu) BO₃, (Y, Eu)₂O₃, (Y, Gd, Eu)₂O₃, or the like. The phosphor thin film forming the green phosphor layer 47 has composition, for example, (Zn, Mn)₂SiO₄, (Y, Tb)BO₃, (Y, Tb)₂O₃, or the like. The phosphor thin film forming the blue phosphor layer 47 has composition, for example, (Ba, Eu)MgAL₁₀O₁₇, (Ca, Eu)MgSi₂O₆, (Y, Tm)₂O₃, or the like.

The transmissive phosphor thin film forming the phosphor layer 47 is produced by the use of CVD (Chemical Vapor Deposition) techniques, sputtering techniques, EB (Electron Beam) deposition techniques or the like.

The PDP in the fourth embodiment further has a circularly-polarized-light filter layer 49 provided on the outer face (display surface) of the front glass substrate 1.

The circularly-polarized-light filter layer 49 is constituted of a phase difference plate (quarter wavelength plate) 49A located on the front glass substrate 1, and a polarizing plate 49B located on the phase difference plate (quarter wavelength plate) 49A.

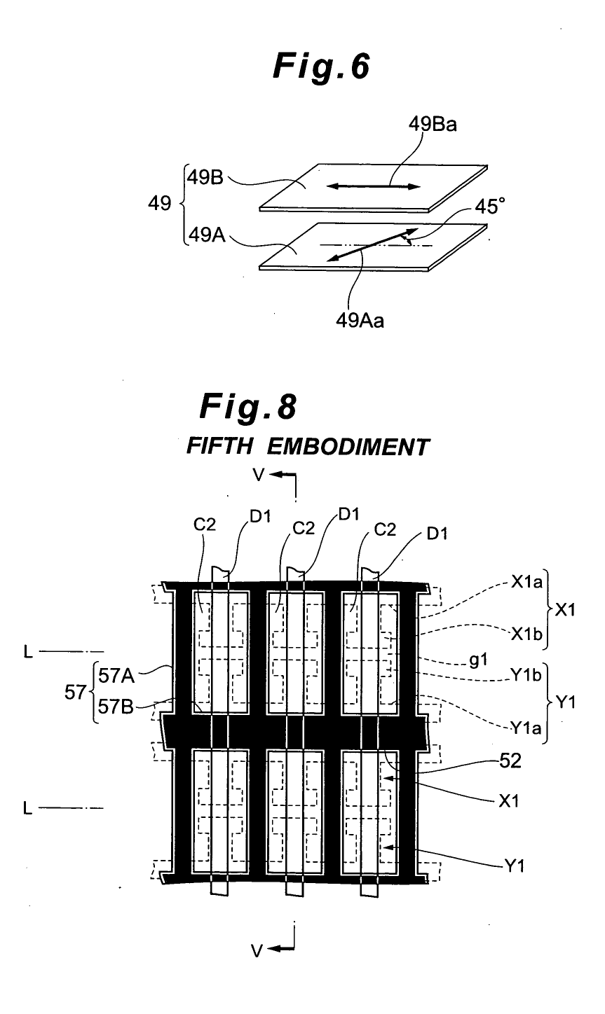

FIG. 6 illustrates the placement of the phase difference plate (quarter wavelength plate) 49A and the polarizing plate 49B of the circularly-polarized-light filter layer 49. The phase difference plate (quarter wavelength plate) 49A and the polarizing plate 49B are positioned in a such way that the phase advance axis (or phase delay axis) 49Aa of the phase difference plate (quarter wavelength plate) 49A and the absorption axis (or transmission axis) 49Ba of the polarizing plate 49B cross each other at an angle of 45 degrees.

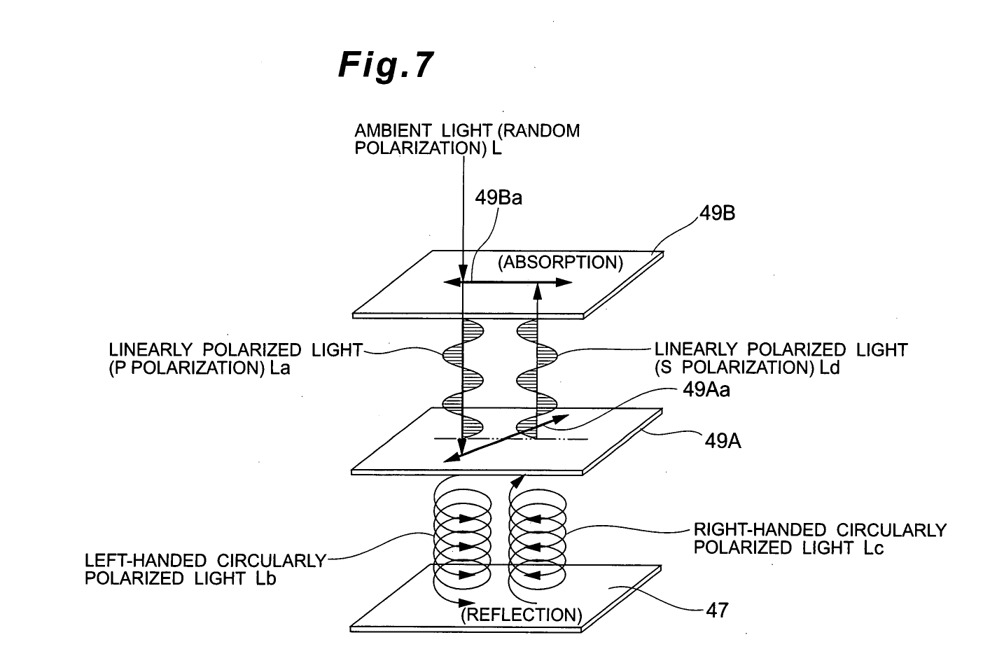

FIG. 7 illustrates the principle of the circularly-polarized-light filter layer 49 curbing the reflection of ambient light.

In FIG. 7, ambient light (random polarization) L which is natural light entering the panel face passes through the polarizing plate 49B of the circularly-polarized-light filter layer 49. At this point, only linearly polarized light (P polarization) La of the ambient light L having a predetermined polarization plane passes through, but the remainder of the polarization planes is absorbed.

Then the linearly polarized light (P polarization) La passing through the polarizing plate 49B is converted to left-handed circularly polarized light Lb when passing through the phase difference plate (quarter wavelength plate) 49A.

Then, the left-handed circularly polarized light Lb passing through the phase difference plate (quarter wavelength plate) 49A is regularly reflected off the surface of the phosphor layer 47 (or alternatively the surfaces of the column-electrode protective layer 5 and/or the partition wall 6 after passing through the phosphor layer 47), and then converted to a circularly polarized light Lc in the opposite direction (in this case, in the right direction).

At this point, because the phosphor layer 47 is formed of a phosphor thin film, as compared with the conventional case of a phosphor layer formed of phosphor powder, the perturbation of the polarization occurring on the reflection face of the phosphor layer 47 is significantly reduced.

Upon returning from the reflection face of the phosphor layer 47 to the phase difference plate (quarter wavelength plate) 49A, the right-handed circularly polarized light Lc is converted to a linearly polarized light (S polarization) Ld having a polarization plane at right angles to the linearly polarized light (P polarization) La at the time of passing through the phase difference plate (quarter wavelength plate) 49A.

In consequence, the linearly polarized light (S polarization) Ld is incapable of passing through the polarizing plate 49B and absorbed by the polarizing plate 49B without issuing from the panel surface.

As in the foregoing, the PDP in the fourth embodiment has the phosphor layer 47 formed of a transmissive phosphor thin film, and the circularly-polarized-light filter layer 49 provided on the outer face of the front glass substrate 1. Therefore, the circularly-polarized-light filter layer 49 prevents the ambient light entering the panel surface from going out from the panel surface, thereby preventing the image contrast from being lowered by the reflection of ambient light. Further, as compared with the PDP having the conventional phosphor layer formed of phosphor powder, because of the phosphor layer 47 formed of a phosphor thin film, the PDP in the fourth embodiment is capable of reducing the perturbation of the polarization on the reflection face of the phosphor layer 47, resulting in enhancement of the effects of the circularly-polarized-light filter layer 49 to prevent the reflection of the ambient light.

In the foregoing, the fourth embodiment describes the circularly-polarized-light filter layer 49 located on the display surface of the front glass substrate 1, but the circularly-polarized-light filter layer 49 may be provided in another position on the front glass substrate 1, for example, in a position between the front glass substrate 1 and the dielectric layer 2.

Further, the circularly-polarized-light filter layer 49 may be provided together with an electro-magnetically sealed layer, a near-infrared-ray absorption layer, an ambient-light-reflection preventing layer or the like on a protective panel mounted on the front of the front glass substrate.

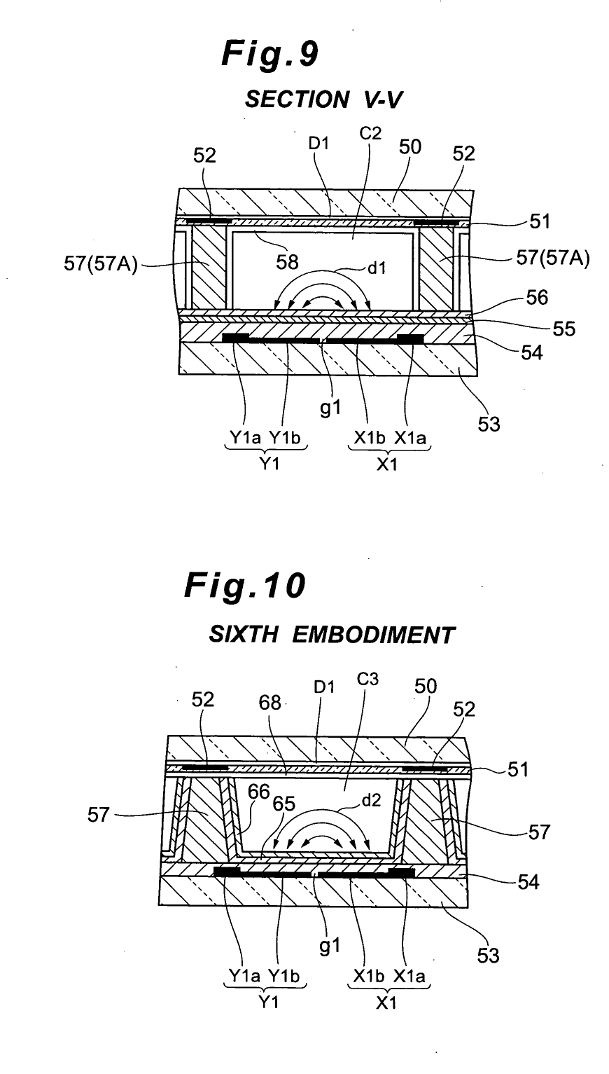

FIGS. 8 and 9 illustrate a fifth embodiment of a PDP according to the present invention.

FIG. 8 is a schematic front view of the PDP in the fifth embodiment. FIG. 9 is a sectional view taken along the V-V line in FIG. 8.

The PDP shown in FIGS. 8 and 9 is of a transmission type, and has transparent-material-made column electrodes D1 provided on the rear-facing face of a front glass substrate 50. The column electrodes D1 each extending in the column direction (i.e. the vertical direction in FIG. 8) are arranged at regular intervals in the row direction (i.e. the right-left direction in FIG. 8).

A transparent dielectric layer 51 is laid on the rear-facing face of the front glass substrate 50 so as to cover the column electrodes D1.

A black- or dark-colored light absorption layer 52 is incorporated into the transparent dielectric layer 51.

The position and shape of the light absorption layer 52 will be described later.

In FIG. 9, the position of the column electrode D1 is closer to the front glass substrate 50 than the position of the light absorption layer 52 is, but this positional relationship may be reversed, that is, the position of the light absorption layer 52 may be closer to the front glass substrate 50.

The front glass substrate 50 is located in parallel to a back glass substrate 53 with the discharge space in between. On the front-facing face of the back glass substrate 53 facing toward the front glass substrate 50 (i.e. the display surface), a plurality of row electrode pairs (X1, Y1) each extending in the row direction of the back glass substrate 53 are arranged regularly in the column direction.

The row electrode X1 is composed of a bus electrode X1a extending in the row direction of the back glass substrate 53, and T-shaped projecting electrodes X1b that are lined up along the bus electrode X1a at regular intervals. The small-width proximal end (corresponding to the foot of the “T” shape) of each projecting electrode X1b is connected to the bus electrode X1a.

Likewise, the row electrode Y1 is composed of a bus electrode Y1a extending in the row direction of the back glass substrate 53, and T-shaped projecting electrodes Y1b that are lined up along the bus electrode Y1a at regular intervals. The small-width proximal end (corresponding to the foot of the “T” shape) of each projecting electrode Y1b is connected to the bus electrode Y1a.

The row electrodes X1 and Y1 are arranged in alternate positions in the column direction of the front glass substrate 53. Each of the projecting electrodes X1b regularly spaced along the bus electrode X1a and the corresponding one of the projecting electrodes Y1b regularly spaced along the bus electrode Y1a are paired with each other in a position opposite the column electrode D1 and extend toward the counterpart in the paired row electrodes such that the widened tops (corresponding to the heads of the “T” shape) of the respective projecting electrodes X1b and Y1b face each other with a discharge gap g1 having a required width in between.

The row electrodes X1, Y1 used may be untransparent. The bus electrode X1a (i.e. Y1a) and the projecting electrodes X1b (i.e. Y1b) may be formed in one piece.

Each of the row electrode pair (X1, Y1) forms a display line L of the panel.

A dielectric layer 54 is provided on the front-facing face of the back glass substrate 53 and covers the row electrode pairs (X1, Y1).

A reflection layer 55 having a high reflectivity for reflecting visible light and vacuum ultraviolet light is provided on the dielectric layer 54.

The reflection layer 55 is required to have a high reflectivity for reflecting visible light and ultraviolet light with wavelengths of 145 to 700 nm. Therefore, the reflection layer 55 may be formed of a dielectric multilayer or metal materials such as aluminum or silver to allow for the aid of optical interference for enhancement of the reflectivity.

More adequate materials for the reflection layer 55 have more reduced tendency to absorb vacuum ultraviolet light. A preferable example of the reflection layer 55 may be formed by laminating YF₃(Nd=1.75) and MgF₂(Nd=1.38) in alternate position.

An MgO-made protective layer 56 is provided on the reflection layer 55. A partition wall 57 is provided on the transparent dielectric layer 51 on the front glass substrate and has the shape as follows.

The partition wall 57 is formed substantially in a grid shape composed of strip-shaped vertical wall members 57A extending in the column direction and strip-shaped transverse wall members 57B extending in the row direction. Each of the vertical wall members 57A is located opposite the mid-position between adjacent column electrodes D1 arranged at regular intervals. Each of the transverse wall members 57B is located opposite a strip between the back-to-back bus electrodes X1a, Y1a of the row electrode pairs (X1, Y1) adjoining to each other.

The partition wall 57 partitions the discharge space defined between the front glass substrate 50 and the back glass substrate 53 into areas each facing the paired transparent electrodes X1b and Y1b in each row electrode pair (X1, Y1) to form quadrangular discharge cells C2.

The front-side shape of the foregoing light absorption layer 52 is approximately the same grid shape as that of the partition wall 57, so that the light absorption layer 52 is located in a position overlapping the vertical wall members 57A and the transverse wall members 57B of the partition wall 57 when viewed from the front glass substrate 50.

In each of the discharge cells C2 defined by the partition wall 57, a phosphor layer 58 overlies the rear-facing face of the transparent dielectric layer 51 and the side faces of the vertical walls 57A and the transverse walls 57B of the partition wall 57. The phosphor layer 58 is formed of a phosphor thin film having visible-light transmission properties.

Red (R), green (G) and blue (B) colors are individually applied to the phosphor layers 58 in the discharge cells C2 for color display so that the red (R), green (G) and blue (B) colors are arranged in order in the row direction or the column direction.

The phosphor thin film forming the red phosphor layer 58 has composition, for example, (Y, Gd, Eu) BO₃, (Y, Eu)₂O₃, (Y, Gd, Eu)₂O₃, or the like. The phosphor thin film forming the green phosphor layer 58 has composition, for example, (Zn, Mn)₂SiO₄, (Y, Tb)BO₃, (Y, Tb)₂O₃, or the like. The phosphor thin film forming the blue phosphor layer 58 has composition, for example, (Ba, Eu)MgAL₁₀O₁₇, (Ca, Eu)MgSi₂O₆, (Y, Tm)₂O₃, or the like.

The transmissive phosphor thin film forming the phosphor layer 58 is formed by the use of CVD (Chemical Vapor Deposition) techniques, sputtering techniques, EB (Electron Beam) deposition techniques or the like.

The discharge space (discharge cells C2) hermetically sealed between the front glass substrate 50 and the back glass substrate 53 is filled with a xenon-included discharge gas.

The PDP in the fifth embodiment produces an addressing discharge between the column electrode D1 formed on the front glass substrate 50 and one row electrode in the row electrode pair (X1, Y1) formed on the back glass substrate 53. Thereafter, a sustaining emission discharge dl is produced between the mutually opposite discharge electrodes X1b and Y1b of the row electrodes X1, Y1 of each row electrode pair (X1, Y1). Thereby, vacuum ultraviolet light is generated from the xenon included in the discharge gas in the discharge space (discharge cells C2). The vacuum ultraviolet light excites each of the phosphor layers 58 of the three primary colors, red, blue and green, so that the phosphor layer 58 emits visible light of the assigned color. Thus, an image according to the image signal is formed.

The phosphor layer 58 is formed of a transmissive phosphor thin film produced by the use of the chemical vapor deposition techniques or the like, and therefore the phosphor layer 58 has an increased density as compared with a conventional phosphor layer formed of a coating of phosphor powder. For this reason, a further increase in the brightness of the panel can be achieved.

Further, because the phosphor layer 58 is formed of a trasmissive phosphor film, the visible light emitted from the phosphor layer 58 excited by the vacuum ultraviolet light is not scattered and absorbed by the phosphor layer 58. This makes it possible to use the phosphor layer in the transmission-type PDP.

Further, the PDP in the fifth embodiment has the reflection layer 55 provided on the back glass substrate 53 and performing the function of reflecting in the direction of the front glass substrate 50 the portions of the vacuum ultraviolet light generated from the xenon in the discharge gas and the visible light emitted from the phosphor layer 58 which travel in the direction of the back glass substrate 53, resulting in the achievement of an further increase in the brightness of the PDP.

Because the reflection layer 55 is located on the back glass substrate 53, the reflection layer 55 is not required to have a high visible-light transmission factor as is done in the case of the location of a ultraviolet-light reflection film on the front glass substrate. As a result, it is possible to improve the luminous efficiency by the use of a simple film structure such as a metal film covered with an insulation layer.

The ambient light entering the non-display zone of the panel (i.e. the area corresponding to the location of the vertical wall members 57A and the transverse wall members 57B of the partition wall 57) is absorbed by the substantially-grid-shaped light absorption layer 52 laid opposite the vertical wall members 57A and the transverse wall members 57B of the partition wall 57 in the non-display zone of the panel. This absorption prevents the reflection of the ambient light to offer the improvement in image contrast.

The fifth embodiment has described the example of the partition wall 57 and the light absorption layer 52 being formed substantially in the grid shape, but this is not limited. For example, the partition wall and the light absorption layer may be formed in a strip shape.

FIG. 10 is a sectional view illustrating a sixth embodiment of a PDP according to the present invention which is taken as in the case of FIG. 9 in the fifth embodiment.

The following is described using the same reference numerals for the same components as those in the PDP in the fifth embodiment.

In FIG. 10, transparent-material-made column electrodes D1 each extend in the column direction (i.e. a direction parallel to the plane of FIG. 10) and are arranged at regular intervals in the row direction (i.e. a direction at right angles to the plane of the FIG. 10) on the rear-facing face of a front glass substrate 50.

A transparent dielectric layer 51 is provided on the rear-facing face of the front glass substrate 50 and covers the column electrodes D1.

Inside the transparent dielectric layer 51, a black- or dark-colored light absorption layer 52 is provided and has the same shape as that in the fifth embodiment.

FIG. 10 illustrates the column electrode D1 positioned closer to the front glass substrate 50 than the light absorption layer 52 is, but this positional relationship may be reversed, that is, the light absorption layer 52 may be positioned closer to the front glass substrate 50.

A phosphor layer 68 made of a phosphor thin film having visible-light transmission properties overlies the rear-facing face of the transparent dielectric layer 51.

Red (R), green (G) and blue (B) colors are individually applied to the phosphor layers 68 in the discharge cells C3 for color display so that the red (R), green (G) and blue (B) colors are arranged in order in the row direction or the column direction.

The phosphor thin film forming the red phosphor layer 68 has composition, for example, (Y, Gd, Eu) BO₃, (Y, Eu)₂O₃, (Y, Gd, Eu)₂O₃, or the like. The phosphor thin film forming the green phosphor layer 68 has composition, for example, (Zn, Mn)₂SiO₄, (Y, Tb)BO₃, (Y, Tb)₂O₃, or the like. The phosphor thin film forming the blue phosphor layer 68 has composition, for example, (Ba, Eu)MgAL₁₀O₁₇, (Ca, Eu)MgSi₂O₆, (Y, Tm)₂O₃, or the like.

The transmissive phosphor thin film forming the phosphor layer 68 is formed by the use of CVD (Chemical Vapor Deposition) techniques, sputtering techniques, EB (Electron Beam) deposition techniques or the like.

The front glass substrate 50 is located parallel to a back glass substrate 53 with the discharge space in between. On the front-facing face of the back glass substrate 53 facing toward the front glass substrate 50 (i.e. the display surface), a plurality of row electrode pairs (X1, Y1) each extending in the row direction of the back glass substrate 53 are arranged regularly in the column direction.

The row electrode X1 is composed of a bus electrode X1a extending in the row direction of the back glass substrate 53, and T-shaped projecting electrodes X1b that are lined up along the bus electrode X1a at regular intervals. The small-width proximal end (corresponding to the foot of the “T” shape) of each projecting electrode X1b is connected to the bus electrode X1a.

Likewise, the row electrode Y1 is composed of a bus electrode Y1a extending in the row direction of the back glass substrate 53, and T-shaped projecting electrodes Y1b that are lined up along the bus electrode Y1a at regular intervals. The small-width proximal end (corresponding to the foot of the “T” shape) of each projecting electrode Y1b is connected to the bus electrode Y1a.

The row electrodes X1 and Y1 are arranged in alternate positions in the column direction of the back glass substrate 53. Each of the projecting electrodes X1b regularly spaced along the bus electrode X1a and the corresponding one of the projecting electrodes Y1b regularly spaced along the bus electrode Y1a are paired with each other in a position opposite the column electrode D1 and extend toward the counterpart in the paired row electrodes such that the widened tops (corresponding to the heads of the “T” shape) of the respective projecting electrodes X1b and Y1b face each other with a discharge gap g1 having a required width in between.

The row electrodes X1, Y1 used may be untransparent. The bus electrode X1a (i.e. Y1a) and the projecting electrodes X1b (i.e. Y1b) may be formed in one piece.

A dielectric layer 54 is provided on the front-facing face of the back glass substrate 53 and covers the row electrode pairs (X1, Y1).

A partition wall 57 formed substantially in a grid shape as in the case of the fifth embodiment is provided on the dielectric layer 54 and partitions the discharge space defined between the front glass substrate 50 and the back glass substrate 53 into areas each facing the paired transparent electrodes X1b and Y1b in each row electrode pair (X1, Y1) to form the quadrangular discharge cells C3.

The position of the aforementioned light absorption layer 52 overlaps the partition wall 57 when viewed from the front glass substrate 50.

A reflection layer 65 having a high reflectivity for reflecting visible light and vacuum ultraviolet light is provided in each discharge cell C3 defined in the discharge space by the partition wall 57 and covers the front-facing face of the dielectric layer 54 and the side faces of the partition wall 57 surrounding the discharge cell C3.

The reflection layer 65 is required to have a high reflectivity for reflecting visible light and ultraviolet light with wavelengths of 145 to 700 nm. Therefore, the reflection layer 65 may be formed of a dielectric multilayer or metal materials such as aluminum or silver to allow for the aid of optical interference for enhancement of the reflectivity.

More adequate materials for the reflection layer 65 have more reduced tendency to absorb vacuum ultraviolet light. A preferable example of the reflection layer 65 may be formed by laminating YF₃(Nd=1.75) and MgF₂(Nd=1.38) in alternate position.

An MgO-made protective layer 66 covers the surface of the reflection layer 65.

The discharge space (discharge cells C3) hermetically sealed between the front glass substrate 50 and the back glass substrate 53 is filled with a xenon-included discharge gas.

The PDP in the sixth embodiment produces an addressing discharge between the column electrode D1 formed on the front glass substrate 50 and one row electrode in the row electrode pair (X1, Y1) formed on the back glass substrate 53. Thereafter, a sustaining emission discharged 2 is produced between the mutually opposite projecting electrodes X1b and Y1b of the row electrodes X1, Y1 of each row electrode pair (X1, Y1). Thereby, vacuum ultraviolet light is generated from the xenon included in the discharge gas in the discharge space (discharge cells C3). The vacuum ultraviolet light excites each of the phosphor layers 68 of the three primary colors, red, blue and green, so that the phosphor layer 68 emits visible light of the assigned color. Thus, an image according to the image signal is formed.

The phosphor layer 68 is formed of a transmissive phosphor thin film produced by the use of the chemical vapor deposition techniques or the like, and therefore the phosphor layer 68 has an increased density as compared with a conventional phosphor layer formed of a coating of phosphor powder. For this reason, a further increase in the brightness of the panel can be achieved.

Further, because the phosphor layer 68 is formed of a trasmissive phosphor thin film, the visible light emitted from the phosphor layer 68 excited by the vacuum ultraviolet light is not scattered and absorbed by the phosphor layer 68. This makes it possible to use the phosphor layer in the transmission-type PDP.

Further, in the PDP in the sixth embodiment, the reflection layer 65, which is provided in each discharge cell C3 and covers the front-facing face of the dielectric layer 54 and the side faces of the partition wall 57 surrounding the discharge cell C3, performs the function of reflecting in the direction of the front glass substrate 50 the portions of the vacuum ultraviolet light generated from the xenon in the discharge gas and the visible light emitted from the phosphor layer 68 which travel in the direction of the back glass substrate 53, resulting in the achievement of an further increase in the brightness of the PDP.

Because the reflection layer 65 covers the front-facing face of the dielectric layer 54 in each discharge cell C3 and the side faces of the partition wall 57 surrounding the discharge cell C3, the reflection layer 65 is not required to have a high visible-light transmission factor as is done in the case of the location of a ultraviolet-light reflection film on the front glass substrate. As a result, it is possible to improve the luminous efficiency by the use of a simple film structure such as a metal film covered with an insulation layer.

While there has been described what are at present considered to be preferred embodiments of the present invention, it will be understood that various modifications may be made thereto, and it is intended that the appended claims cover all such modifications as fall within the true spirit and scope of the present invention.

What is claimed is:

1. A plasma display panel, comprising:
a front substrate and a back substrate facing each other with a discharge space in between;
a phosphor layer provided on the back substrate for colored-light emission by means of a discharge produced in the discharge space, and formed of a phosphor thin film having visible-light transmission properties; and
either a black-colored or a dark-colored layer provided on a face of the phosphor layer opposite a face facing toward the front substrate.

2. A plasma display panel according to claim 1, wherein the phosphor layer is provided on a column-electrode protective layer covering column electrodes provided on the back glass substrate, and the column-electrode protective layer serves as either the black-colored or the dark-colored layer.

3. A plasma display panel according to claim 2,
wherein the discharge space is partitioned into unit light emission areas by a partition wall provided on the back glass substrate, the phosphor layer is provided on side faces of the partition wall, and the partition wall serves as either the black-colored or the dark-colored layer.

4. A plasma display panel according to claim 1, wherein the phosphor layer is provided on a column-electrode protective layer covering column electrodes provided on the back glass substrate, and either the black-colored or the dark-colored layer is provided between the column-electrode protective layer and phosphor layer.

5. A plasma display panel according to claim 4,
wherein the discharge space is partitioned into unit light emission areas by a partition wall provided on the back glass substrate, the phosphor layer is provided on side faces of the partition wall, and either the black-colored or the dark-colored layer is provided between the partition wall and the phosphor layer.

6. A plasma display panel according to claim 1, wherein the phosphor layer is formed by use of one of chemical vapor deposition techniques, electron beam deposition techniques and sputtering techniques.

7. A plasma display panel, comprising:
a front substrate and a back substrate facing each other with a discharge space in between; and
a phosphor layer provided on the back substrate for colored-light emission by means of a discharge produced in the discharge space, and formed of a phosphor thin film having visible-light transmission properties and a refractive index smaller than a refractive index of a portion of the back substrate in contact with the phosphor layer, and having a film thickness corresponding to approximately a quarter wavelength of light.

8. A plasma display panel according to claim 7, wherein the phosphor layer is provided on a column-electrode protective layer covering column electrodes provided on the back glass substrate, and has a refractive index smaller than a refractive index of the column-electrode protective layer.

9. A plasma display panel according to claim 8,
wherein the discharge space is partitioned into unit light emission areas by a partition wall provided on the back glass substrate, the phosphor layer is provided on side faces of the partition wall and has a refractive index smaller than a refractive index of the partition wall.

10. A plasma display panel, comprising:
a front substrate and a back substrate facing each other with a discharge space in between;
a phosphor layer provided on the back substrate for colored-light emission by means of a discharge produced in the discharge space, and formed of a phosphor thin film with visible-light transmission properties; and
a circularly-polarized-light filter layer provided on the front substrate.

11. A plasma display panel, comprising:
a front substrate and a back substrate facing each other with a discharge space in between;
a phosphor layer provided on the front substrate for emitting visible light by means of ultraviolet light generated in the discharge space, and formed of a phosphor film having visible-light transmission properties; and
a reflection layer provided on the back substrate for reflecting at least the ultraviolet light.

12. A plasma display panel according to claim 11,
wherein the discharge space is partitioned into unit light emission areas by a partition wall provided on the back glass substrate, the phosphor layer is provided on a rear-facing face of the front glass substrate and side faces of the partition wall.

13. A plasma display panel according to claim 11,
wherein the discharge space is partitioned into unit light emission areas by a partition wall provided on the back glass substrate, the reflection layer is provided on a display-surface-facing face of the back glass substrate and side faces of the partition wall.

14. A plasma display panel according to claim 11, further comprising:
column electrodes provided on a rear-facing face of the front glass substrate,
row electrodes provided on the back glass substrate; and
a column-electrode protective layer provided on the rear-facing face of the front glass substrate to cover the column electrodes, and has visible-light transmission properties.

15. A plasma display panel according to claim 11, wherein the phosphor layer is formed by use of one of chemical vapor deposition techniques, electron beam deposition techniques and sputtering techniques.

16. A plasma display panel according to claim 11, wherein the reflection layer reflects visible light.

17. A plasma display panel according to claim 11, wherein the reflection layer has a reflectivity for reflecting visible light and ultraviolet light with wavelengths of 145 to 700 nm.

18. A plasma display panel according to claim 11, wherein the reflection layer is formed by use of either aluminum or silver.

19. A plasma display panel according to claim 11, wherein the reflecting of the reflection layer is performed by means of optical interference caused by a dielectric in multilayer form.
